(19) United States
(12) Patent Application Publication
(10) Pub. No.: US 2024/0210606 A1
(43) Pub. Date: Jun. 27, 2024

(54) INFRARED LIGHT-TRANSMITTING PRODUCT

(71) Applicant: TOYODA GOSEI CO., LTD., Kiyosu-shi, Aichi-ken (JP)

(72) Inventors: Shiho HATTORI, Kiyosu-shi, Aichi-ken (JP); Shintaro OKAWA, Kiyosu-shi, Aichi-ken (JP); Koji KUNO, Kiyosu-shi, Aichi-ken (JP); Seiichi SUZUKI, Saitama-shi, Saitama (JP)

(21) Appl. No.: 18/556,589

(22) PCT Filed: Apr. 27, 2022
(86) PCT No.: PCT/JP2022/019012

§ 371 Date: Oct. 20, 2023

(30) Foreign Application Priority Data
Apr. 30, 2021 (JP) 2021-077267

(51) Int. Cl. G02B 5/20; B60Q 3/60; B60Q 3/70; B60Q 3/51

(52) U.S. Cl. CPC G02B 5/208; B60Q 3/60; B60Q 3/70; B60Q 3/51

(57) ABSTRACT

An infrared transmissive product includes a main body configured to cover both a light-emitting unit for emitting infrared light and a light-receiving unit for receiving infrared light in an infrared detector. The main body is transmissive to infrared light. The main body includes a base member that absorbs visible light and a red light absorbing layer disposed on a rear surface of the base member in a traveling direction of infrared light from the light-emitting unit. The red light absorbing layer absorbs red light in a wavelength region of 700 nm to 900 nm.

### TECHNICAL FIELD

The present disclosure relates to an infrared transmissive product.

### BACKGROUND ART

In recent years, vehicles equipped with driver monitoring systems have been developed. The driver monitoring system uses an infrared camera installed in the vehicle to capture images of the driver and analyze these images to detect movements of the driver's eyes and the orientation of the face of the driver. Based on the detected eye movements and face orientation, the driver monitoring system monitors whether the driver is distracted or nodding off.

Patent Literature 1 discloses a driver assistance module (hereinafter referred to as the assistance module) that forms such a driver monitoring system. This assistance module includes a light-emitting diode that emits infrared light towards the driver on a spoke of the steering wheel of an automobile. The assistance module includes an outer wall that covers the light-emitting diode. The outer wall includes a translucent portion that allows infrared light to pass through.

By irradiating the driver with infrared light from the light-emitting diode, the

clarity of the images captured by the infrared camera is enhanced.

### CITATION LIST

### Patent Literature

Patent Literature 1: Japanese National Phase Laid-Open Patent Publication No. 2018-502003

### SUMMARY OF INVENTION

### Technical Problem

Infrared light consists of electromagnetic waves with wavelengths ranging from 700 nm to 1 mm. The infrared light emitted from the light-emitting diode includes red light in a wavelength region of 700 nm to 900 nm. Therefore, in the assistance module disclosed in Patent Literature 1, red light contained in the infrared light emitted from the light-emitting diode is visually recognized by the driver through the translucent portion of the outer wall. As a result, the driver may become aware of the presence of the assistance module, including the light-emitting diode, potentially giving the driver a psychological resistance to being monitored by the infrared camera.

Additionally, the glowing red of the translucent portion might compromise the aesthetic appeal of the vehicle's interior component, and thereby its marketability.

Such problems are not limited to infrared transmissive products used in systems that monitor vehicle drivers, but commonly occur in infrared transmissive products with a main body that covers the infrared light-emitting unit of an infrared detector and is transmissive to infrared light.

### Solution to Problem

To achieve the foregoing objective and in accordance with a first aspect, an infrared transmissive product includes a main body configured to cover both a light-emitting unit for emitting infrared light and a light-receiving unit for receiving infrared light in an infrared detector. The main body is transmissive to infrared light. The main body includes a base member that absorbs visible light and a red light absorbing layer disposed on a rear surface of the base member in a traveling direction of infrared light from the light-emitting unit. The red light absorbing layer absorbs red light in a wavelength region of 700 nm to 900 nm.

To achieve the foregoing objective and in accordance with a second aspect, an infrared transmissive product includes a main body configured to cover a light-emitting unit of infrared light of an infrared detector. The main body is transmissive to infrared light. The main body includes a base member that absorbs visible light and a red light absorbing layer disposed on a rear surface of the base member in a traveling direction of infrared light from the light-emitting unit. The red light absorbing layer limits transmission of red light in a wavelength region of 700 nm to 900 nm.

### BRIEF DESCRIPTION OF DRAWINGS

FIG. 1 is a side view showing a driver who is seated in a driver's seat of a vehicle and holds a steering wheel.

FIG. 2 is a front view of the steering wheel.

FIG. 3 is an enlarged front view mainly showing a cover of the steering wheel.

FIG. 4 is a cross-sectional view taken along line 4-4 in FIG. 3.

FIG. 5 is a graph showing a relationship between wavelengths and the light transmissivity of the cover.

### DESCRIPTION OF EMBODIMENTS

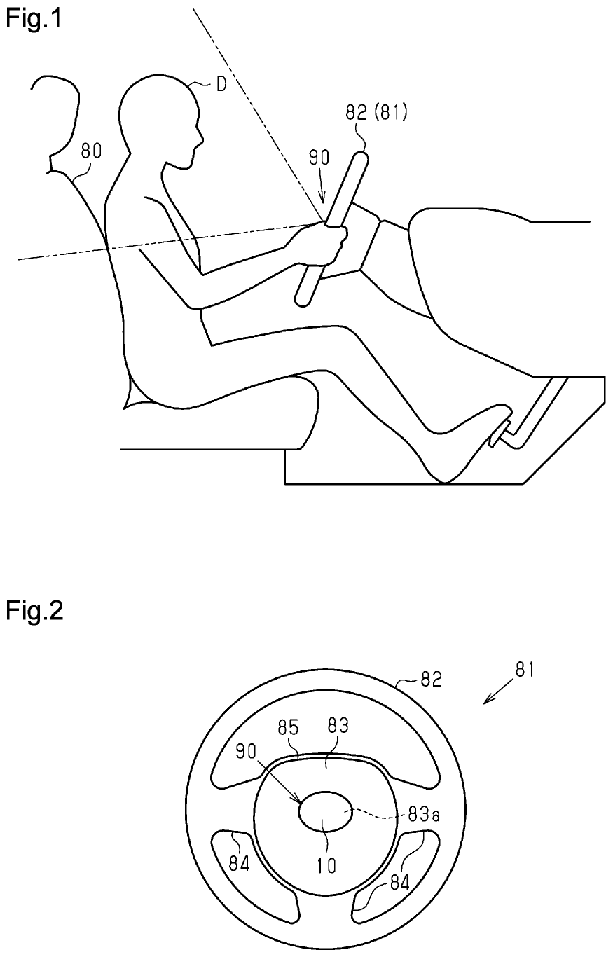

An infrared transmissive product according to an embodiment will now be described with reference to FIGS. 1 to 5.

In the present embodiment, the infrared transmissive product is employed as a cover 10 of an infrared camera device 90 mounted on a steering wheel 81 of a vehicle. The infrared camera device 90 is part of a system that monitors a driver D of the vehicle.

As shown in FIG. 1, the steering wheel 81, which is part of a steering device, is provided in front of a driver's seat 80 of the vehicle.

As shown in FIG. 2, the steering wheel 81 includes a ring portion 82, a pad portion 83, and spoke portions 84.

The ring portion 82 is gripped and rotated by the driver D.

The pad portion 83 is disposed in a space surrounded by the ring portion 82.

The spoke portions 84 are located between the ring portion 82 and the pad portion 83 at one or more positions (three positions in FIG. 2) around the axis of the ring portion 82.

The steering wheel 81 includes an airbag apparatus 85. The pad portion 83 forms a part of the airbag apparatus 85.

The pad portion 83 includes a through-hole 83a at the center.

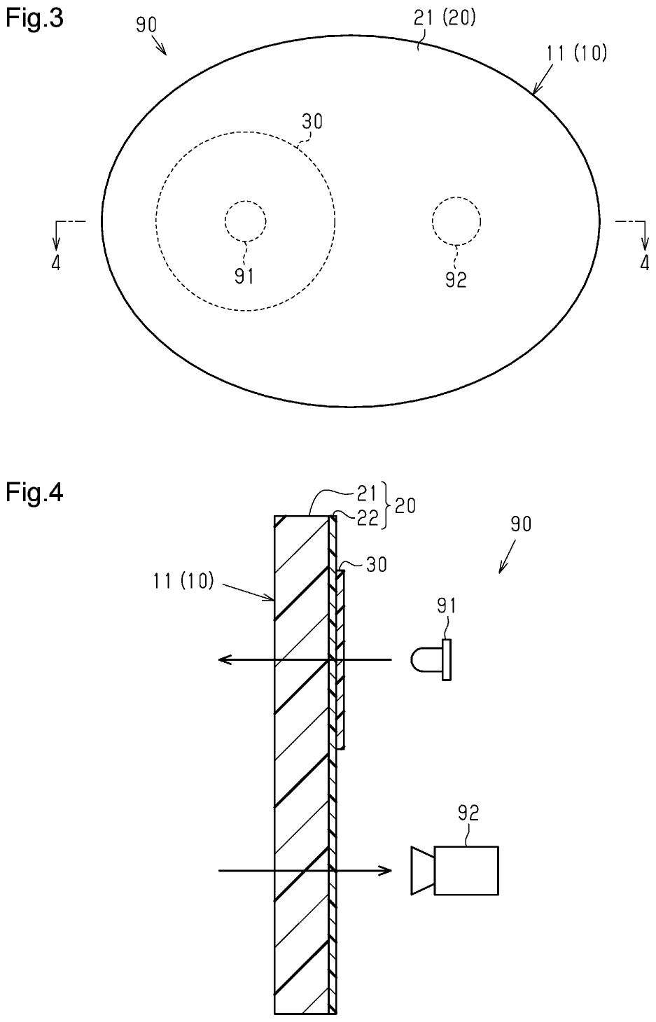

As shown in FIGS. 3 and 4, the infrared camera device 90 includes a light-emitting unit 91 for emitting infrared light and a light-receiving unit 92 for receiving infrared light. The light-emitting unit 91 and the light-receiving unit 92 are disposed inside the pad portion 83.

The cover 10 is attached to the pad portion 83 (refer to FIG. 2). The cover 10 includes a main body 11 that closes the through-hole 83a and covers the light-emitting unit 91 and the light-receiving unit 92. The main body 11 is transmissive to infrared light. The cover 10 includes an attachment portion (not shown) with which the cover 10 is attached to the through-hole 83a.

The main body 11 is located between the driver D and the position where both the light-emitting unit 91 and the light-receiving unit 92 are provided.

The light-emitting unit 91 is configured to emit infrared light to the driver D to illuminate the driver D. The light-emitting unit 91 is, for example, a light-emitting diode (LED). The central wavelength of the infrared light emitted from the light-emitting unit 91 is 940 nm.

The light-receiving unit 92 is configured to receive the infrared light from the driver D. The light-receiving unit 92 is, for example, a sensor capable of receiving infrared light (infrared sensor).

The light-emitting unit 91 and the light-receiving unit 92 are spaced apart from each other. In the present embodiment, the light-emitting unit 91 and the light-receiving unit 92 are arranged side by side in the vehicle width direction (the left-right direction as viewed in FIGS. 3 and 4).

In the following description, the ‘front’ and ‘rear’ in the direction in which the infrared light from the light-emitting unit 91 travels will simply be referred to as ‘front’ and ‘rear’.

As shown in FIG. 4, the main body 11 includes a base member 20 and a red light absorbing layer 30. The base member 20 absorbs visible light. The red light absorbing layer 30 is arranged on the rear surface of the base member 20 and absorbs red light in a wavelength region of 700 nm to 900 nm.

The base member 20 includes a base member body 21, which is made of a transparent plastic, and a visible light absorbing layer 22, which is provided on the rear surface of the base member body 21 to absorb visible light.

The transparent plastic forming the base member body 21 is, for example, polycarbonate, polymethyl methacrylate, cycloolefin polymer, or plastic glass.

### Visible Light Absorbing Layer 22

The visible light absorbing layer 22 is provided on the entire rear surface of the base member body 21.

The visible light absorbing layer 22 absorbs visible light and is transmissive to infrared light.

The visible light absorbing layer 22 includes a black coating film layer. The coating film layer is formed by combining a transparent plastic and at least two types of dyes/pigments that are transmissive to infrared light and produce a black color when mixed together. The visible light absorbing layer 22 may contain a curing agent as necessary.

The transparent plastic as used herein contains at least one of the following as a main component: epoxy plastic, silicone plastic, urethane, urea-formaldehyde plastic, phenol plastic, polyethylene, polypropylene, polyethylene terephthalate, vinyl chloride, polystyrene, acrylonitrile-butadiene-styrene copolymer, acrylic plastic, polyamide, polyimide, polycarbonate, and melamine plastic. The main component refers to a component that affects the properties of the material, and the content of the main component is greater than or equal to 50% by mass.

A curing agent is used depending on the material of the transparent plastic. If the transparent plastic used herein contains epoxy plastic as the main component, an acid anhydride curing agent or a phenol curing agent may be used. If the transparent plastic used herein contains a material other than epoxy plastic as the main component, a curing agent may be omitted.

Depending on the purpose and the intended use, a curing agent other than an acid anhydride curing agent or a phenol curing agent may be used. Examples of such curing agents include an amine-based curing agent, an agent obtained by partially esterifying an acid anhydride curing agent with alcohol, and a curing agent of carboxylic acid such as hexahydrophthalic acid, tetrahydrophthalic acid, and methyl-hexahydrophthalic acid. One of the listed curing agents may be used alone. Alternatively, two or more of the curing agents may be used in combination. Further, any of the curing agents may be used with an acid anhydride curing agent and a phenol curing agent.

The dyes/pigments are selected from a group consisting of the following dyes and all the pigments that can be used as color pigments.

Examples of the dye include an azo dye, an anthraquinone dye, an indigoid dye, a carbonium dye, a quinonimine dye, a quinoline dye, a chrome dye, an indanthrene dye, a triphenylmethane dye, a phthalocyanine dye, a procion dye, a methine dye, a nitro dye, a nitroso dye, a benzoquinone dye, a naphthoquinone dye, a naphthalimide dye, a perinone dye, and a remazol dye.

Examples of the pigment include titanium dioxide, zinc oxide, iron oxide, calcined pigment, isoindolinone, isoin, doline, azomethine, anthraquinone, anthrone, xanthene, diketopyrrolopyrrole, perinone, perylene, indigoid, quinacridone, dioxazine, and phthalocyanine. Particularly, oil-soluble dye/pigment is preferable in order to achieve even dispersion into the visible light absorbing layer 22.

Two or more types of dyes/pigments that meet the following conditions are selected from the groups of the dyes/pigments shown above, and used.

The dyes/pigments each have a color different from a black color but produce a black color when mixed together. The black color is a color that absorbs and blocks all colors without reflecting light.

The dyes/pigments have a property of being unable to absorb visible light of specific regions different from each other.

When mixed together, the dyes/pigments are capable of absorbing visible light that cannot be absorbed by each of the dyes/pigments alone.

Specifically, dyes/pigments of complementary colors are selected. An example is a combination of a purple dye/pigment and a green dye/pigment. A purple dye/pigment is obtained by mixing, for example, a red dye/pigment and a blue dye/pigment. Also, a green dye/pigment is obtained by mixing, for example, a yellow dye/pigment and a blue dye/pigment.

In a case in which a curing agent is used, a curing accelerator may be used together with the curing agent. In order to complement, for example, the property of allowing infrared light to pass through, antioxidant, deterioration inhibitor, denaturant, coupling agent, antifoaming agent, leveling agent, or mold release agent may be used.

The visible light absorbing layer 22 has a thickness in the range of 5 μm to 50 μm. The visible light absorbing layer 22 contains 50 to 150 mass part of dyes/pigments in relation to 100 mass part of transparent plastic.

In the visible light absorbing layer 22, which is configured as described above, the light transmissivity is 10% or lower in the wavelength region of 400 nm to 600 nm. The light transmissivity in the wavelength region of 800 nm to 1700 nm is 70% or higher. The light transmissivity used herein is an average value in a wavelength region.

### Red Light Absorbing Layer 30

On the rear surface of the base member 20, that is, on the rear surface of the visible light absorbing layer 22, the red light absorbing layer 30 is provided in a section that is forward of the light-emitting unit 91, but is not provided in a section that is forward of the light-receiving unit 92.

The red light absorbing layer 30 is a coating film layer formed by blending a dye that absorbs red light into a transparent plastic. The red light absorbing layer 30 may contain a curing agent as necessary.

As the transparent plastic and the curing agent, the same materials as the transparent plastic and the curing agent forming the visible light absorbing layer 22 may be employed.

The dye is a near-infrared absorption pigment. The chemical name of the dye is 1-{2,2-bis[4-(diethylamino)phenyl]vinyl}-3,3-bis[4-(diethylamino)phenyl]propa-2-en-1-ylium=p-toluenesulfonate.

The red light absorbing layer 30 has a thickness in the range of 10 μm to 100 μm. The red light absorbing layer 30 contains 3.0 to 10.0 mass part of dye in relation to 100 mass part of transparent plastic.

In the red light absorbing layer 30, which is configured as described above, the light transmissivity is 10% or lower in the wavelength region of 700 nm to 900 nm. The light transmissivity in a wavelength region of 900 nm to 1700 nm of the red light absorbing layer 30 is 70% or higher. The light transmissivity used herein is an average value in the above wavelength region.

### EXAMPLES

Examples of the red light absorbing layer 30 will now be described with reference to Table 1.

TABLE 1

| Dye Addition | Thickness (μm) | | | | | | | | |
|---|---|---|---|---|---|---|---|---|---|
| Amount (%) | 15 | 20 | 30 | 40 | 50 | 60 | 70 | 80 | 85 |
| 1.0 | Δ2 | Δ2 | Δ2 | Δ2 | Δ2 | Δ2 | Δ2 | Δ2 | ◯ |
| 1.5 | Δ2 | — | — | — | — | — | — | — | — |
| 2.0 | Δ2 | Δ2 | ◯ | ◯ | ◯ | ◯ | Δ1 | Δ1 | Δ1 |
| 2.5 | Δ2 | — | — | — | — | — | — | — | — |
| 3.0 | ◯ | ◯ | ◯ | ◯ | Δ1 | Δ1 | Δ1 | Δ1 | Δ1 |
| 3.5 | X | X | X | X | X | X | X | X | X |
| 4.0 | X | X | X | X | X | X | X | X | X |

In these examples, Condition 1 was the light transmissivity at the wavelength of 900 nm being 10% or lower. Condition 2 was the light transmissivity of infrared light at the wavelength of 940 nm being 70% or higher.

In Table 1, a case in which both Condition 1 and Condition 2 were met is represented by 0. A case in which only Condition 1 was met is represented by Δ1. A case in which only Condition 2 was met is represented by Δ2. A case in which neither Condition 1 nor Condition 2 were met is represented by x.

As shown in Table 1, when the amount of dye added to the red light absorbing layer 30 (hereinafter, simply referred to as dye addition amount) was 1.0%, only Condition 2 was met when the thickness of the coating film layer was in a range of 15 μm to 80 μm (Δ2). When the thickness of the coating film layer was 85 μm, both Condition 1 and Condition 2 were met (∘).

When the dye addition amount was 2.0%, only Condition 2 was met when the thickness of the coating film layer was in a range of 15 μm to 20 μm (Δ2). When the thickness of the coating film layer was in a range of 30 μm to 60 μm, both Condition 1 and Condition 2 were met (∘). When the thickness of the coating film layer was in a range of 70 um to 85 μm, only Condition 1 was met (Δ1).

When the dye addition amount was 3.0% and the thickness of the coating film layer was in a range of 15 μm to 40 μm, both Condition 1 and Condition 2 were met (∘). When the thickness of the coating film layer was in a range of 50 μm to 85 μm, only Condition 1 was met (Δ1).

When the dye addition amount was 3.5% or 4.0%, the dye was not dissolved, so that paint was not obtained.

Operation of the present embodiment will now be described.

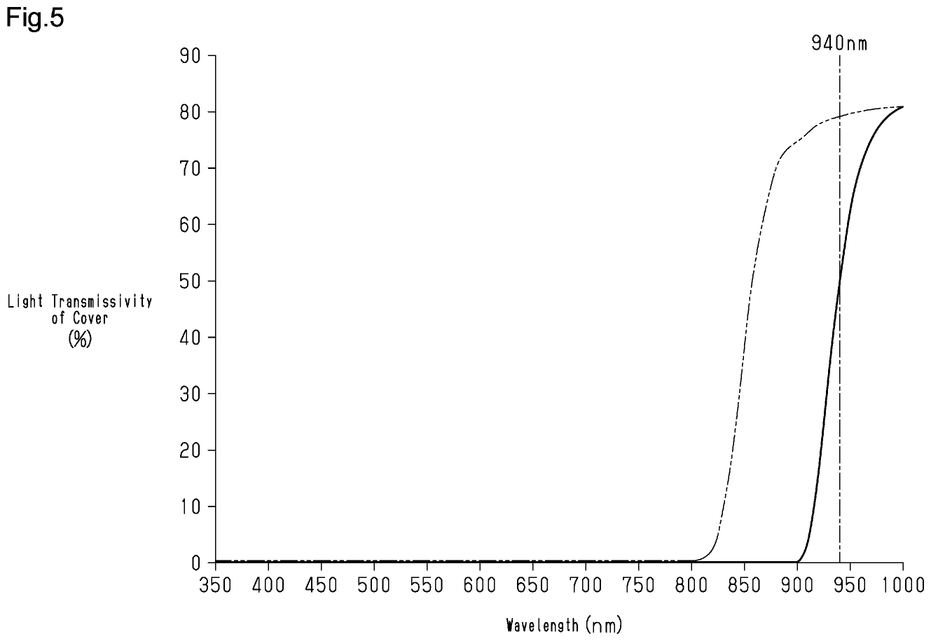

FIG. 5 shows a relationship between wavelengths of light and the light transmissivity of the cover 10 of the present embodiment with a solid line. FIG. 5 also shows a relationship between wavelengths of light and the light transmissivity of a cover of a comparative example with a long-dash double-short-dash line. The cover of the comparative example only includes the base member 20, but does not include the red light absorbing layer 30.

As shown in FIG. 5, in the case of the cover 10 of the present embodiment, the base member 20 absorbs visible light. As a result, the light-emitting unit 91 and the light-receiving unit 92 are unlikely to be visually recognized. The same operation is achieved by the cover of the comparative example.

In the case of the cover 10 of the present embodiment, the red light absorbing layer 30 absorbs the red light in the wavelength region of 700 nm to 900 nm. Accordingly, it is possible to prevent the red light included in the infrared light emitted from the light-emitting unit 91 from being visually recognized through the main body 11.

The present embodiment has the following advantages.

(1) The cover 10 includes the main body 11, which is transmissive to infrared light. The main body 11 includes the base member 20, which absorbs visible light, and the red light absorbing layer 30, which is arranged on the rear surface of the base member 20 in the traveling direction of the infrared light from the light-emitting unit 91. The red light absorbing layer 30 absorbs red light in the wavelength region of 700 nm to 900 nm.

This configuration operates in the above-described manner and thus prevents red light from being visually recognized through the main body 11.

(2) The light transmissivity in a wavelength region of 700 nm to 900 nm of the red light absorbing layer 30 is 10% or lower.

This configuration reliably prevents the red light included in the infrared light emitted from the light-emitting unit 91 from being visually recognized through the main body 11.

(3) The light transmissivity in a wavelength region of 900 nm to 1700 nm of the red light absorbing layer 30 is 70% or higher. This configuration ensures the detection accuracy for infrared light of the infrared camera device 90, while preventing the red light included in the infrared light emitted from the light-emitting unit 91 from being visually recognized through the main body 11.

(4) The base member 20 includes the base member body 21, which is made of a transparent plastic, and the visible light absorbing layer 22, which is provided on the rear surface of the base member body 21 to absorb visible light.

This configuration reduces the amount of material used as compared with a case in which a material that absorbs visible light is mixed throughout the base member 20.

(5) On the rear surface of the base member 20, the red light absorbing layer 30 is provided in the section that is forward of the light-emitting unit 91, but is not provided in the section that is forward of the light-receiving unit 92.

With this configuration, the red light absorbing layer 30 is disposed in the section of the rear surface of the base member 20 that is forward of the light-emitting unit 91. This prevents the red light included in the infrared light emitted from the light-emitting unit 91 from being visually recognized through the main body 11.

Also, the section of the rear surface of the base 20 that is forward of the light-receiving unit 92 is not provided with the red light absorbing layer 30. This prevents infrared light directed toward the light-receiving unit 92 from being absorbed when passing through the main body 11. This prevents the detection accuracy of the infrared camera device 90 from being reduced.

In addition, the amount of material used for the red light absorbing layer 30 is reduced, as compared to a case in which the red light absorbing layer 30 is disposed on the entire rear surface of the base member 20.

(6) The red light absorbing layer 30 is a coating film layer formed by blending a dye that absorbs red light into a transparent plastic.

This configuration allows the red light absorbing layer 30 to be readily formed on a part of the rear surface of the base member 20.

(7) The infrared detector is the infrared camera device 90, which forms a system for monitoring the driver of a vehicle. The light-emitting unit 91 is configured to emit infrared light to the driver D to illuminate the driver D. The light-receiving unit 92 is configured to receive the infrared light from the driver D. The main body 11 forms the cover 10, which is located between the driver D and a section including the light-emitting unit 91 and the light-receiving unit 92, and covers the light-emitting unit 91 and the light-receiving unit 92.

Since this configuration prevents red light from being visually recognized through the main body 11, the presence of the infrared camera device 90 is not recognized by the driver. This configuration improves the aesthetic appeal of the vehicle's interior components including the cover 10.

### MODIFICATIONS

The above-described embodiment may be modified as follows. The above-described embodiment and the following modifications can be combined as long as the combined modifications remain technically consistent with each other.

The red light absorbing layer 30 is not limited to a coating film layer, but may be a sheet. In this case, a sheet simply needs to be bonded to the rear surface of the base member 20. This modification achieves operational advantages similar to the above-described operational advantages (1) to (5), and (7).

The red light absorbing layer 30 may be provided on the entire rear surface of the base member 20. This modification achieves operational advantages similar to the above-described operational advantages (1) to (4), (6), and (7).

The base member 20 is not limited to the one that includes both the base member body 21 and the visible light absorbing layer 22. That is, the visible light absorbing layer 22 may be omitted, and the entire base member may be configured to absorb visible light.

The light transmissivity in the wavelength region of 700 nm to 900 nm of the red light absorbing layer 30 may be 10% or higher if red light is prevented from being visually recognized through the main body 11.

The light transmissivity in the wavelength region of 900 nm to 1700 nm of the red light absorbing layer 30 may be lower than 70% if it is possible to ensure a desired detection accuracy of the infrared camera device 90.

The light-emitting unit 91 and the light-receiving unit 92 of the infrared camera device 90 do not need to be provided inside the pad portion 83 of the steering wheel 81, but may be provided outside the pad portion 83. Further, the light-emitting unit 91 and the light-receiving unit 92 of the infrared camera device 90 may be arranged in the instrument panel of the vehicle. In this case, the cover 10 forms a part of the instrument panel.

The infrared transmissive product according to the present disclosure is not limited to the cover 10, which is configured to cover both the light-emitting unit 91 and the light-receiving unit 92 of the infrared camera device 90, which is part of a system for monitoring the driver D of the vehicle. Alternatively, for example, the present disclosure may be embodied as a cover configured to cover a light-emitting unit and a light-receiving unit of an infrared detection device mounted on a vehicle to detect the surrounding environment of the vehicle.

The infrared transmissive product according to the present disclosure is not limited to one that is configured to cover both the light-emitting unit and the light-receiving unit of an infrared detector, but may be modified if the product covers at least the light-emitting unit. That is, the infrared transmissive product according to the present disclosure may be configured to not cover the light-receiving unit. In this case, the light-receiving unit portion may be covered with another infrared transmissive product that does not include a red light absorbing layer.

1. An infrared transmissive product, comprising:
a main body configured to cover both a light-emitting unit for emitting infrared light and a light-receiving unit for receiving infrared light in an infrared detector, the main body being transmissive to infrared light,
wherein the main body includes:
a base member that absorbs visible light; and
a red light absorbing layer disposed on a rear surface of the base member in a traveling direction of infrared light from the light-emitting unit, the red light absorbing layer absorbing red light in a wavelength region of 700 nm to 900 nm.

2. The infrared transmissive product according to claim 1, wherein a light transmissivity in the wavelength region of the red light absorbing layer is 10% or lower.

3. The infrared transmissive product according to claim 1, wherein a light transmissivity in a wavelength region of 900 nm to 1700 nm of the red light absorbing layer is 70% or higher.

4. The infrared transmissive product according to claim 1, wherein the base member includes:
a base member body made of a transparent plastic; and
a visible light absorbing layer, which is provided on a rear surface of the base member body and absorbs visible light.

5. The infrared transmissive product according to claim 1, wherein, on the rear surface of the base member, the red light absorbing layer is provided in a section forward of the light-emitting unit and is not provided in a section forward of the light-receiving unit.

6. The infrared transmissive product according to claim 1, wherein the red light absorbing layer is a coating film layer formed by blending a dye that absorbs the red light into a transparent plastic.

7. The infrared transmissive product according to claim 1, wherein
the infrared detector is an infrared camera device that forms a system for monitoring a driver of a vehicle,
the light-emitting unit is configured to emit infrared light to the driver to illuminate the driver,
the light-receiving unit is configured to receive infrared light from the driver, and
the main body forms a cover that is located between the driver and a section including the light-emitting unit and the light-receiving unit, and covers the light-emitting unit and the light-receiving unit.

8. An infrared transmissive product, comprising:
a main body configured to cover a light-emitting unit of infrared light of an infrared detector, the main body being transmissive to infrared light,
wherein the main body includes:
a base member that absorbs visible light; and
a red light absorbing layer disposed on a rear surface of the base member in a traveling direction of infrared light from the light-emitting unit, the red light absorbing layer limiting transmission of red light in a wavelength region of 700 nm to 900 nm.
